(19) United States
(12) Patent Application Publication
(10) Pub. No.: US 2014/0068664 A1
(43) Pub. Date: Mar. 6, 2014

(54) METHOD FOR ADDING AN OBJECT MAP TO A VIDEO SEQUENCE

(71) Applicant: Keith Edward Bourne, Southfield, MI (US)

(72) Inventor: Keith Edward Bourne, Southfield, MI (US)

(21) Appl. No.: 14/019,359

(22) Filed: Sep. 5, 2013

Related U.S. Application Data
(60) Provisional application No. 61/697,023, filed on Sep. 5, 2012.

(51) Int. Cl. H04N 21/44

(52) U.S. Cl. CPC H04N 21/44016
USPC 725/35

(57) ABSTRACT

A method to provide image recognition within a video and to add time-based data to the video. The time-based data is from a manually or automatically classified and indexed video database. The time-based data is dependent upon the recognized image within the video. Hence, the time-based data is available as a function of times when the image is available.

### CROSS-REFERENCE TO RELATED APPLICATIONS

This application claims the priority benefit of U.S. Provisional Application 61/697,023 filed Sep. 5, 2012, which is herein incorporated by reference in its entirety.

### TECHNICAL FIELD

This disclosure is related to linking data to a video sequence. Specifically, the disclosure discusses methods to link data to time-dependent objects within the video sequence.

### BACKGROUND

The statements in this section merely provide background information related to the present disclosure. Accordingly, such statements are not intended to constitute an admission of prior art.

Currently, viewers can receive mobile video channels (e.g. a broadcast television channel) on a mobile device. Most communication between the broadcaster and the viewer is one-way, with the broadcaster sending video content and the viewer receiving it. Advertising is somewhat limited, with advertisers targeting markets related to the overall theme of a video instead portions of content within the video.

Furthermore, viewer communication to the broadcaster is very limited. For example a viewer can select a channel and perhaps even a video clip on a channel, but the broadcaster doesn't receive viewer feedback on pieces of content within the video.

### SUMMARY

The method for a broadcaster to add an object map with linked data to a video residing on a server comprises: broadcasting the video to a viewer; linking an object(s) within the video to an object map(s), wherein each object is linked to one object map; having the broadcaster enter data associated with the object, wherein the data comprise elements which define object(s) characteristics; having the broadcaster specify the time-frame that each object map remains linked to each object within the video; receiving viewer data from the viewer; and providing a data overlay to the viewer, wherein the data overlay is advertising which is dependent upon a combination of object data, object map data, and viewer data.

Broadcasting the video to a viewer can be any type of video content sent to any type of video receiving device using any type of broadcast medium. Examples of video content include but are not limited to mobile TV for extreme sports, mobile TV for luxury, and the like. Examples of video receiving devices include but are not limited to cell phones, PDAs, laptops, and the like. Examples of broadcast mediums include but are not limited to the internet, wifi, cell phone bandwidths, and the like.

Object in video is selected using an object map (i.e. a set of coordinates corresponding with a particular area on the screen). Multiple object maps are also possible, each with their own associated data.

User enters data to be associated with object map. This data stored in a data file that uses a video ID to associate with the video. Data fields can include elements such as a video ID that associates this data with the proper video, starting and ending coordinates of the map on the video, other coordinate information recording movements of the object map along with time markers, name of the advertiser, type of product, name of product, unique ID associated with the product (such as an ASID or UPC), hyperlink for product information on Internet, keywords and other metadata, description of the object in the object map and what is occurring in the video, information about people or places in the video, GPS coordinates of locations in the video, and instructions for the device to take actions (such as shake or turn on a mobile service), start time, end time, and other related data.

In one embodiment, search engine data is generated. The data that is added to the video is indexed and associated with time frames in the video (scenes). This data is used in a local search engine, allowing the user to go directly to a moment in the video that is most relevant to their search criteria. This data can also be fed to third-party search engines (such as Google®, Bing®, YouTube®, etc.), allowing users of those search engines to go directly to a moment in the videos that is most relevant to their search criteria. This data can also be fed to advertising platforms on mobile and online, as well as any other platform that utilizes data to deliver content more relevant to their users.

The data overlay technology works with third-party videos served from any hosted video serving source, including, but not limited YouTube®, Vimeo®, Brightcove®, and a local video serving environment. For any video that is hosted publicly, the data overlay data collected can be exposed to the large search engines, making users of those search engines able to go directly to a specific moment in the video most relevant to their search criteria.

For every object map applied to the video, the image within that object map is captured and also stored to the database associated with the data applied to it within the overlay. As this data collection grows, algorithms are applied that take all the data collected, identifies common words used across multiple images and then identifies the groupings of pixels within those images that share similar characteristics, such as color, proximity to each other, contrast differences between adjoining pixels, and the like. The method can then crawl other video from a local video collection, or that is publicly available on the web, find similar groupings of pixels within those video images, and overlay these common terms automatically to those videos. These new data overlays are then stored in a search engine index, which allows users to search for and find specific moments in those videos that are the most relevant to their search criteria.

For example, there might be hundreds of images of a brown shoe in videos that have been indexed using this pixel grouping algorithm, with the term “brown shoe” used in the object map data overlay associated with those images. These images are captured and stored with that associated data. Then, when “crawling” new video that is publicly available, or has been added to the video library (but has not had the data overlay applied yet), we can apply the term “brown shoe” to any images that are have similar pixel grouping characteristics which are similar to the images that have already been indexed. This enables automatic classification and indexing of any video, whether it is in the local video library or available on the web for “crawling”.

In one embodiment, Auto-key framing (e.g. scenes) is utilized. When a video is indexed, the user can split it up by any time frame they wish, but the most typical split is by scene-related time segments. Scene time frames can be automatically identified based on significant changes to the background and pixel patterns in the video. The significant changes enable the application of those time frames automatically, dramatically reducing the time associated with applying the data overlay to new videos. This combined with the automatic adding of the key terms in the data overlay, allows the automatic creation of precise and robust data indexes of any video.

The objects that are mapped in the video can be manually or automatically indexed.

Object motion tracking within a video can be performed in a number of ways. In one embodiment, Object motion tracking uses an algorithm to detect points and or regions within the object map that differ in a variety of properties, such as brightness or color, compared to their surroundings. These differences provide the boundaries of the object being tracked and this feedback is used to alter the coordinates of the object map to move and resize it and stay aligned with object as it moves and changes size in the video.

User also defines the timeframe that this object map remains associated with the object in the video. As the slider is moved, the video moves with it, until the user notes where it ends (or the object disappears).

As the video moves, and the objects in the video that are mapped move, they may change size. These motions will be tracked to resize the object map as it changes size with time changes.

Additional data is associated with all object data on screen at any particular time. This includes location information on the user, IP Address of their device, viewer demographic information (sex, age, income level, and similar data), viewer preference information (such as favorite shows or favorite activity related to the channel), and viewer behavior (such as visit counts, click/tap counts on each object map, direct purchases and revenue, and similar data).

Combination of object map data and the additional data retrieved are used to deliver highly customized advertising in a side panel within the same interface as the video.

All of the data collected from the object map(s), the device data, and the user data are combined.

This combination of data is used to deliver advertising that takes all of this information into account. For example, a local surf shop can place advertising that will appear when there is a surfboard on the screen, when the user has designated surfing as a favorite sport, and the user is within 20 miles of their location.

The ads can be shown when the user selects the object or they can be shown in other parts of the same screen (such as along the side, bottom, or top).

Advertisements come from a separate database/platform that collects advertising media from the advertisers, including what keywords they wish to associate with, what demographics to target, and other similar settings.

Exposure to a viewer is also tracked to the individual level and to the specific object map, so that advertisers can determine how many times a viewer has been exposed to a particular advertisement. While some web services will track basic stats, such as number of hits in aggregate, this platform ties the number of times an individual viewer is associated with a specific advertisement, so that marketers can measure the amount of exposure necessary to impact the conversion rate of their efforts.

Combining the data associated with the object maps with location based data, viewer demographic data, and viewer behaviors (such as clicking or tapping on objects with similar metadata) to deliver advertising and other content relevant to what is being viewed, what the viewer's interests are, and/or informational data for the viewer to learn more about the video.

Method for applying object map data onto video within a mobile device—allows users to add data on top of video feed tied to specific video frames and specific to specific parts of the video interface (i.e. in just one part of the video on top of a person or place or thing within the video) with movement tracking and adjustment of the object map based on changes in the size of the object on the screen. In one embodiment, the data is written to a separate data file and then stored in association with the video.

In a separate embodiment, the data cited in the paragraph above is getting written to a flat file data file that contains time-based data related to the video allowing the receiving device to coordinate the object maps with the video. This data file can be transmitted in parallel with the video and parsed locally into the data format for each mobile platform. It is configurable with any other data feed technology (which currently includes JSON, XML, and other similar data feed languages).

In a separate embodiment, the method embeds coding which is undetectable to the human eye, but readable by computers and mobile devices, into images on display (such as wall posters, kiosk artwork, showroom displays, and other similar items used for display of images). This coding is scanned by a mobile device with software, and the user is taken into a certain part of a video related to what they just scanned. Alternatively, the embedded coding can initiate a sequence in the device that allows the user to watch a video that has transparent parts to it and is shown over the camera image of the actual display (in real life). So the user can see an actual scene take place on that display through their device. This has applications in more than just advertising, and can be used for purposes such as, but not limited to: training; event management; interactive displays at amusement parks, museums, zoos, and other similar locations; gaming; and other similar activities.

In a separate embodiment, the method uses matrix codes (such as QR and similar codes). This coding is scanned by a mobile device with software, and the data transmitted from this code into the camera of the device is used by the device to take the user into a certain part of a video related to what they just scanned.

In a separate embodiment, object maps are used to link between videos or other assets contained within the application (or databases the application has access to), allowing the user to pull up similar content easier and go directly to the place in the video where that related content is similar. So for example, if they are watching a general show on extreme sports that happens to show someone surfing, they can click/tap on that person and/or surfboard and it can bring up the option to see other videos that have surfing in them. The object maps in other videos identify what videos have surfing, and those videos are pulled up and provided in a list. The user can be provided with the option to go directly to the point where the surfing occurs in each of the videos. These actions that show the users interests and intent can then be recorded and utilized to display more relevant advertising and information to that user.

Click (or tap for touch interfaces) overlay: allows user to add a click/tap map that tracks motion of this person, place, or thing within the video and resizes based on the movement and changing dynamics of that person, place or thing. The click/tap map can contain more than just hyperlinks, it can contain: metadata with keywords; and data that triggers the device to take an action (such as shake).

There are many possible embodiments of the layout. The video and the data can be displayed in variety of combinations, with the video to the far left, or far right, near the top, or near the bottom, or in the middle. The data added through the object map can be displayed to the right, left, above, or below the video. Any of the data associated with the object maps in the video can be presented in a way that allows the user to jump forward and/or backward to different points in the video based on the time frame that was associated with the object map. Any of the data associated with the object maps can be organized into similar categories, such as people, scenes, locations, experiences, products, and any other category of data captured, which can then be presented in groups based on this categorization. These categorized groups can be presented to the user, and they can select to go directly to a point in the video associated with that category or a specific object map listed within that category.

The user of the application (e.g. the broadcaster) applies an object map to a video frame (i.e. one point in the video), placing it around the object that is the subject of the data that will be added. This object map can take the form of a rectangle defined by the coordinates of its corners, an ellipse defined by a mathematical equation representing its outer border, or by a border drawn exactly to the outer border of the object represented by many coordinates and angle degrees. In one embodiment, these object maps are applied manually, in another embodiment; these object maps are applied automatically to objects within videos based on similarities with snapshot images captured previously from other object maps. In another embodiment, the entire video screen is an object map, and all objects within that video frame are tagged with the same data. An unlimited number of object maps can be applied to any video frame and they can be overlapping. In one embodiment, these object maps are carried to each of the preceding video frames after the frame that the original object map was applied until it gets to the ending point selected by the user. In another embodiment the object is tracked within the object map, which follows the object if it moves within the video, and changes shape based on changes in size by the object as the video proceeds.

The scope of the invention is defined by the claims, which are incorporated into this section by reference. A more complete understanding of embodiments on the present disclosure will be afforded to those skilled in the art, as well as the realization of additional advantages thereof, by consideration of the following detailed description of one or more embodiments. Reference will be made to the appended sheets of drawings that will first be described briefly.

The following detailed description of the invention is merely exemplary in nature and is not intended to limit the invention or the application and uses of the invention. Furthermore, there is no intention to be bound by any theory presented in the preceding background of the invention or the following detailed description of the invention.

### BRIEF DESCRIPTION OF THE DRAWINGS

One or more embodiments will now be described, by way of example, with reference to the accompanying drawings, in which:

FIG. 1 is a block diagram of a typical computing environment used for implementing embodiments of the present disclosure.

FIG. 2 is a screen shot of a provided video file.

FIG. 3 is a screen shot of an object map within a video file.

FIG. 4 is a screen shot of an object map and associated data file within a video file.

FIG. 5 is a screen shot of an object map and associated time-frame within a video file.

FIG. 6A is a screen shot of an object map within a video file at a first time and location.

FIG. 6B is a screen shot of the object map within the video file at a second time and location.

FIG. 7 is a screen shot of an object map and associated ancillary data file within a video file.

FIG. 8 is a screen shot of time and video dependent customized advertising, delivered based upon an object map and data file(s) within a video file.

FIG. 9 is a screen shot of tracked viewer exposure to time and video dependent customized advertising, delivered based upon an object map and data file(s) within a video file.

FIG. 10 is a flowchart showing an embodiment of the method.

FIG. 11 is a network diagram using a local search engine.

FIG. 12 is a network diagram using a third-party search engine.

### DETAILED DESCRIPTION

The present disclosure presents a method to overcome the limitations cited in the background and further the current state of the art. A broadcaster would not only broadcast video clips for a channel, but the video clips would have individual elements identified within the video. These elements could change location and possibly even properties (e.g. color) within the video clip over time. Broadcaster tracking of elements enables targeted advertisements, with the broadcaster serving advertisements which are linked to individual elements. As elements within a video change, advertisements can also change.

Examples of Mobile TV channel combined with functionality specific to a market are MobileTV for Extreme Sports with customized functionality and MobileTV for Luxury.

Examples of MobileTV for Extreme Sports with customized functionality are allowing users to upload pics of their adventures and tie them to locations in the shows, allowing users to create trip plans based on the videos they are watching (e.g. make instant purchases of everything for that trip), and enabling interactive map features allowing users to navigate to trips and shows points of interest via a map.

Examples of MobileTV for Luxury are reservations at VIP places, check-ins, and tracking friends attending locations, to see when they attended in the past.

In one embodiment, the method enables functionality for each mobile channel that is specifically tailored to the target market of that channel. Examples are extreme sports, travel, or related channels.

Viewers can tie their own information to a location of a certain show. Some information can be shown publicly, while other information can be used personally by the viewer. Data that is associated for the user can include: Planning tips; check lists for trip planning; location tracking while on the trip; and recording of video, images, and notes from the trip, and the ability to share these with friends, groups, and publicly, as well as associate them with the show that went to the same location.

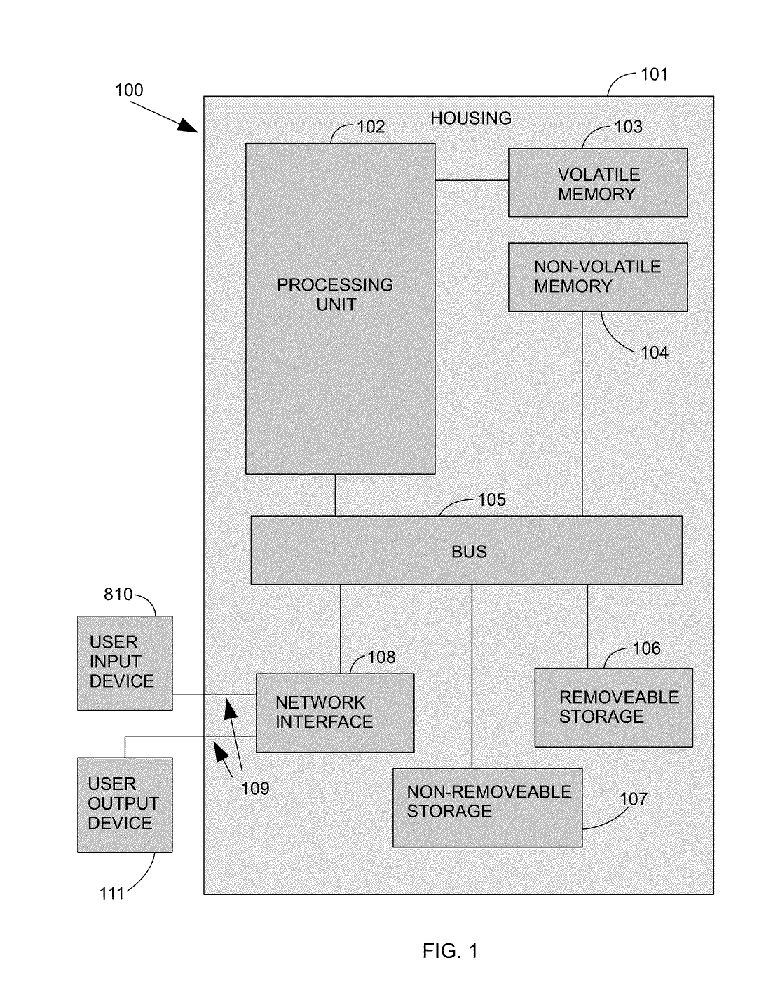

FIG. 1 is a block diagram of a typical computing environment used for implementing embodiments of the present disclosure. FIG. 1 shows a computing environment 100, which can include but is not limited to, a housing 101, processing unit 102, volatile memory 103, non-volatile memory 104, a bus 105, removable storage 106, non-removable storage 107, a network interface 108, ports 109, a user input device 110, and a user output device 111.

Various embodiments of the present subject matter can be implemented in software, which may be run in the environment shown in FIG. 1 or in any other suitable computing environment. The embodiments of the present subject matter are operable in a number of general-purpose or special-purpose computing environments. Some computing environments include personal computers, server computers, hand-held devices (including, but not limited to, telephones and personal digital assistants (PDAs) of all types, iPods, and iPads), laptop devices, tablet devices, multi-processors, microprocessors, set-top boxes, programmable consumer electronics, network computers, minicomputers, mainframe computers, distributed computing environments, and the like to execute code stored on a computer readable medium. The embodiments of the present subject matter may be implemented in part or in whole as machine-executable instructions, such as program modules that are executed by a computer. Generally, program modules include routines, programs, objects, components, data structures, and the like to perform particular tasks or to implement particular abstract data types. In a distributed computing environment, program modules may be located in local or remote storage devices.

A general computing device, in the form of a computer, may include a processor, memory, removable storage, non-removable storage, bus, and a network interface.

A computer may include or have access to a computing environment that includes one or more user input modules, one or more user output modules, and one or more communication connections such as a network interface card or a USB connection. The one or more output devices can be a display device of a computer, computer monitor, TV screen, plasma display, LCD display, display on a digitizer, display on an electronic tablet, display on a cell phone, display on a smart phone, and the like. The computer may operate in a networked environment using the communication connection to connect one or more remote computers. A remote computer may include a personal computer, server, router, network PC, a peer device or other network node, and/or the like. The communication connection may include a Local Area Network (LAN), a Wide Area Network (WAN), and/or other networks.

Memory may include volatile memory and non-volatile memory. A variety of computer-readable media may be stored in and accessed from the memory elements of a computer, such as volatile memory and non-volatile memory, removable storage and non-removable storage. Computer memory elements can include any suitable memory device(s) for storing data and machine-readable instructions, such as read only memory (ROM), random access memory (RAM), erasable programmable read only memory (EPROM), electrically erasable programmable read only memory (EEPROM), hard drive, removable media drive for handling compact disks (CDs), digital video disks (DVDs), diskettes, magnetic tape cartridges, memory cards, memory sticks, and the like. Memory elements may also include chemical storage, biological storage, and other types of data storage.

“Processor” or “processing unit” as used herein, means any type of computational circuit, such as, but not limited to, a microprocessor, a microcontroller, a complex instruction set computing (CISC) microprocessor, a reduced instruction set computing (RISC) microprocessor, a very long instruction word (VLIW) microprocessor, an explicitly parallel instruction computing (EPIC) microprocessor, a graphics processor, a digital signal processor, program logic controller (PLC), field programmable gate array (FPGA), or any other type of processor or processing circuit. The term also includes embedded controllers, such as generic or programmable logic devices or arrays, application specific integrated circuits, single-chip computers, smart cards, and the like.

Embodiments of the present subject matter may be implemented in conjunction with program modules, including functions, procedures, data structures, application programs, etc. for performing tasks, or defining abstract data types or low-level hardware contexts.

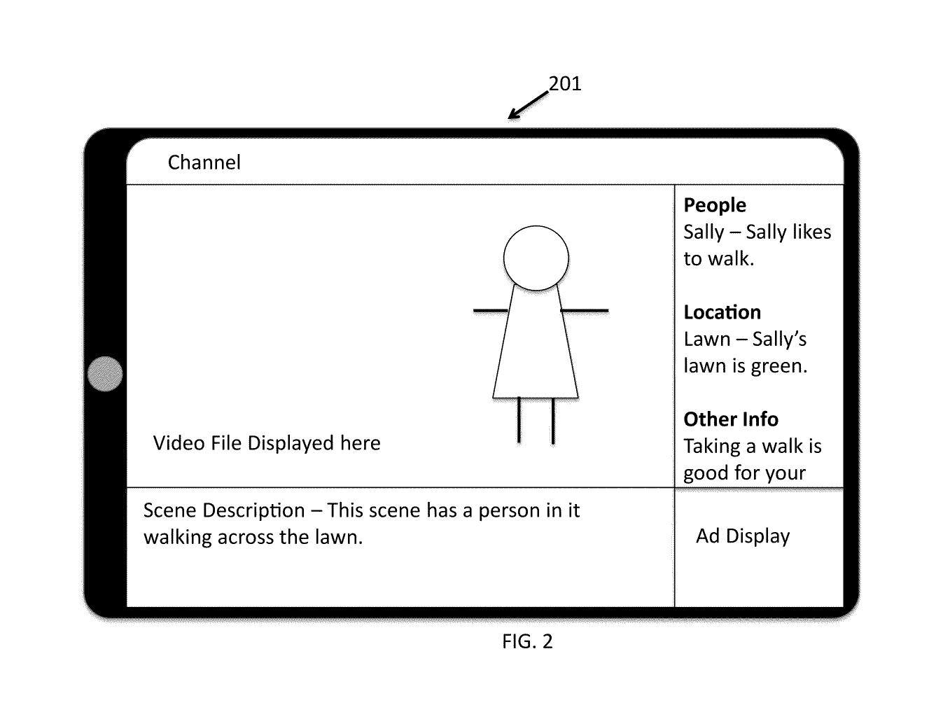

FIG. 2 is a screen shot of a provided video file. Shown is a screen 201, which is sectioned into different areas where different video data can be shown.

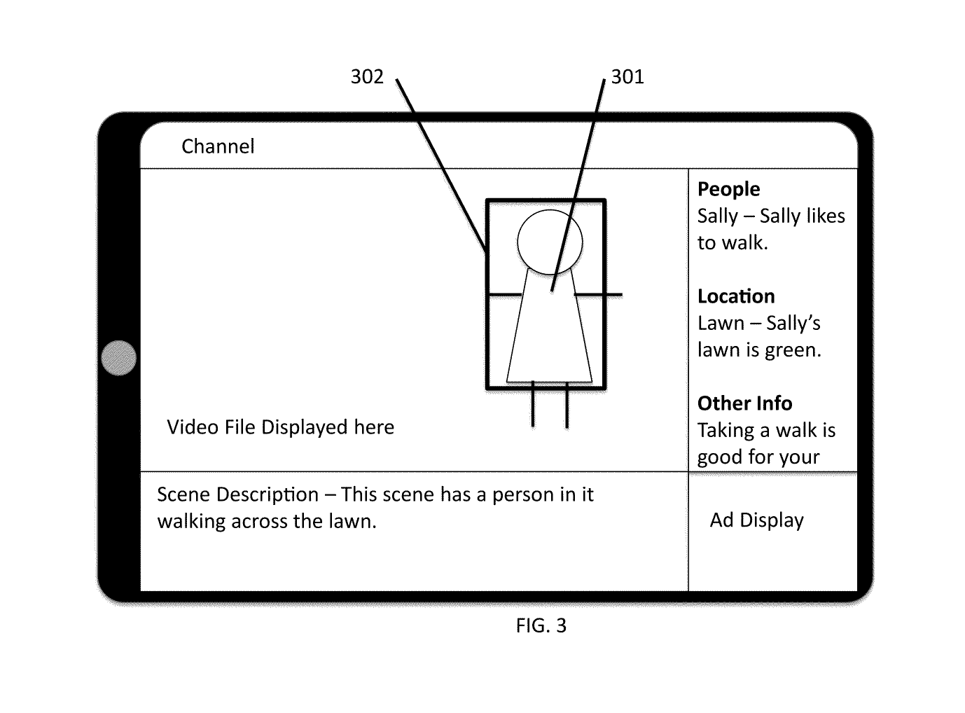

FIG. 3 is a screen shot of an object map within a video file. An object 301 in a video file is selected using an object map 302, wherein the object map 302 is a set of coordinates corresponding to a particular area of the video file. Note that the border used to define the object map 302 is not visible to a viewer.

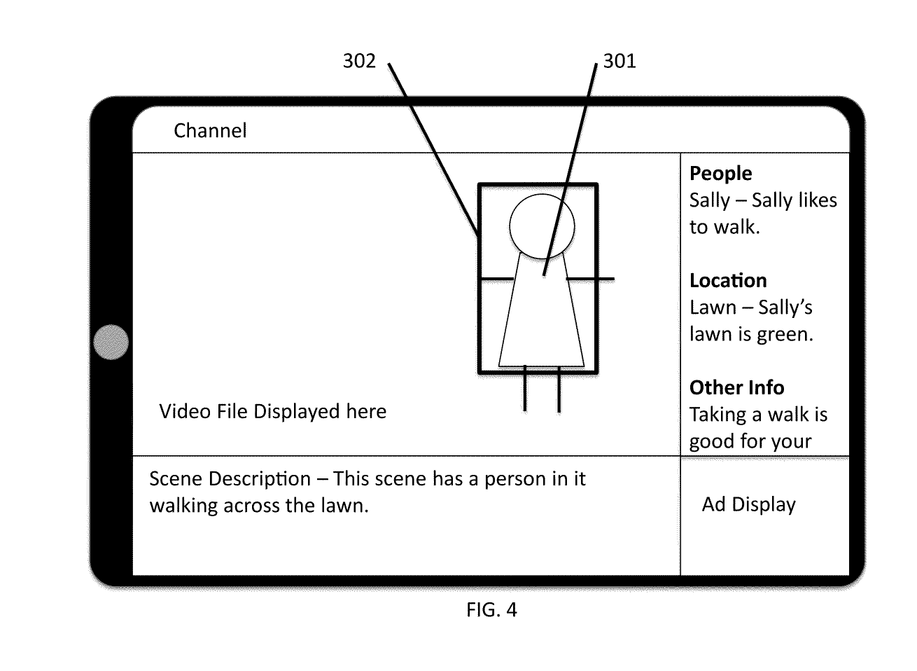

FIG. 4 is a screen shot of an object map and associated data file comprising elements which are defined with common words or a description (defined by the user) within a video file. A broadcaster or video provider, also known as a user, enters data to be associated with the object map 302 in an associated data file. A video identifier is used to link the object map 302 with the associated data file.

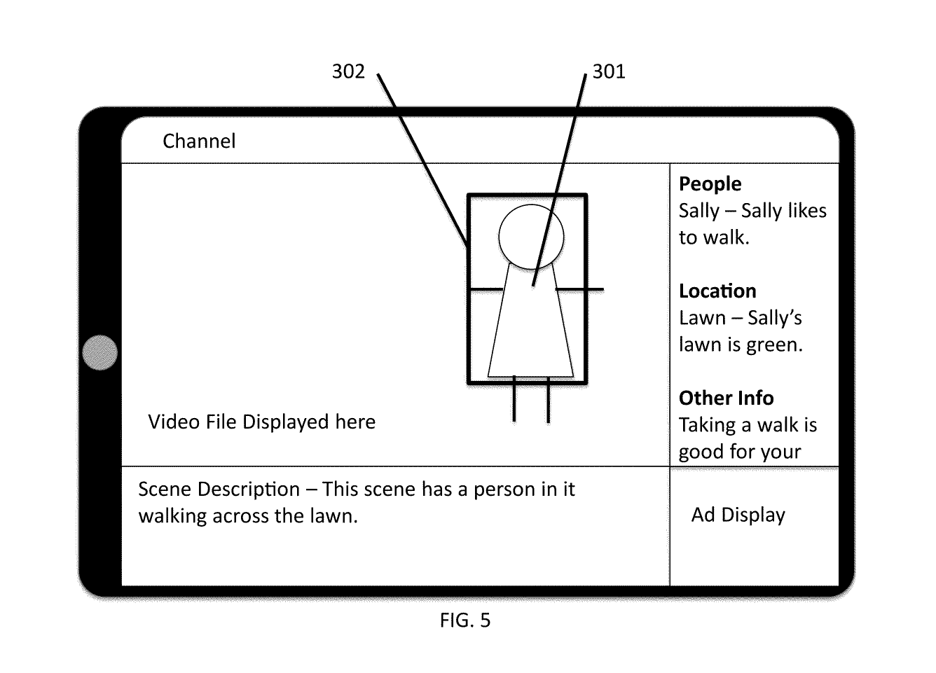

FIG. 5 is a screen shot of an object map and associated time-frame within a video file. The user defines a timeframe that the object map 302 remains associated with the object 301 in the video. As a slider representing time is moved, the video changes with time, until the user notes when it ends (or the object disappears).

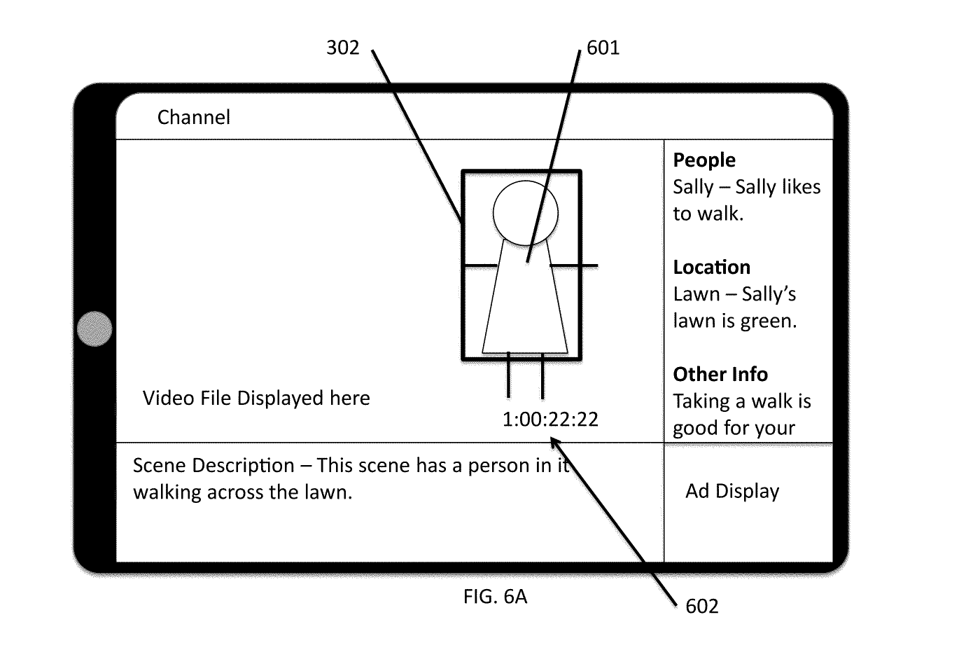

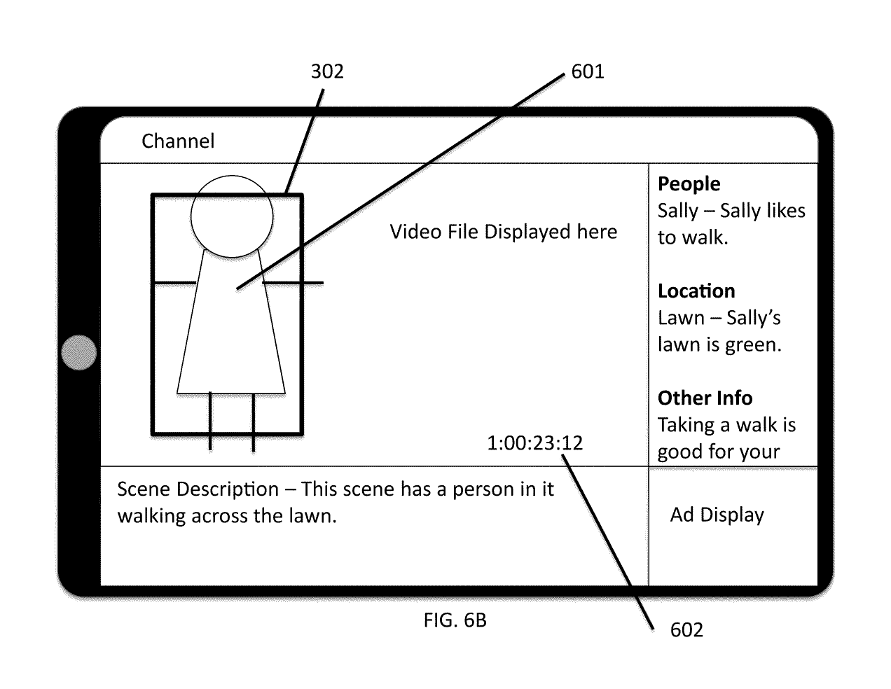

FIG. 6A is a screen shot of an object map within a video file at a first time and location. FIG. 6B is a screen shot of the object map within the video file at a second time and location. As the video moves, and the mapped objects 601 in the video move, the mapped objects 601 may change size. These motions will be tracked to resize the object map 302 as it changes size with time changes. A time-stamp 602 is also shown.

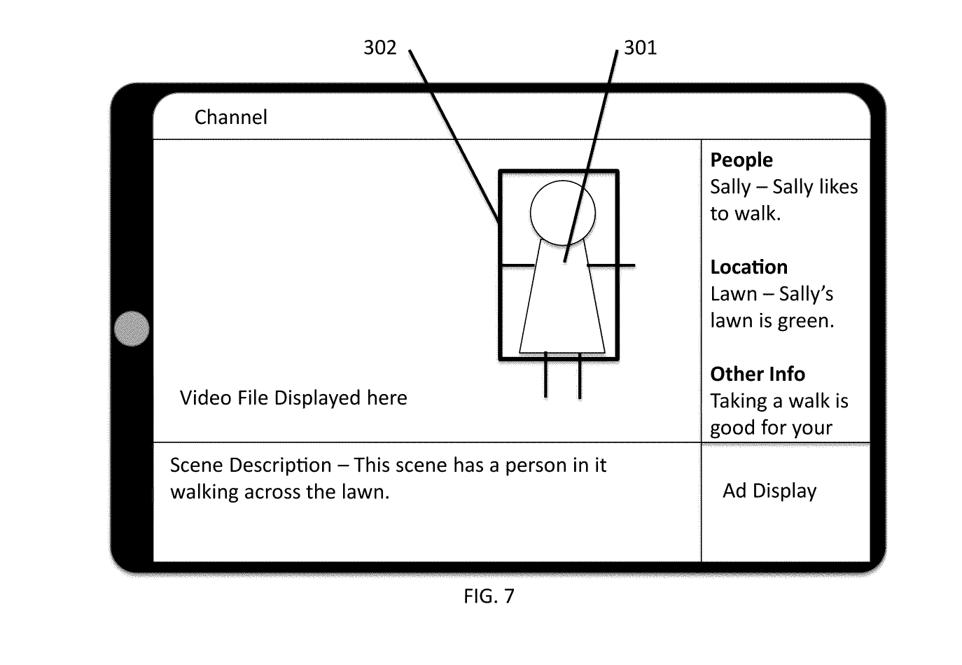

FIG. 7 is a screen shot of an object map and associated ancillary data file within a video file. The associated ancillary data file is additional data which is associated with all of the object data on the screen (in the video) at any particular time. This includes but is not limited to viewer location information, user location information, viewer demographic information, viewer information (e.g. visit counts, click/tap counts on each object, direct purchases, etc.), and the like. The object 301 and object map 302 are also shown.

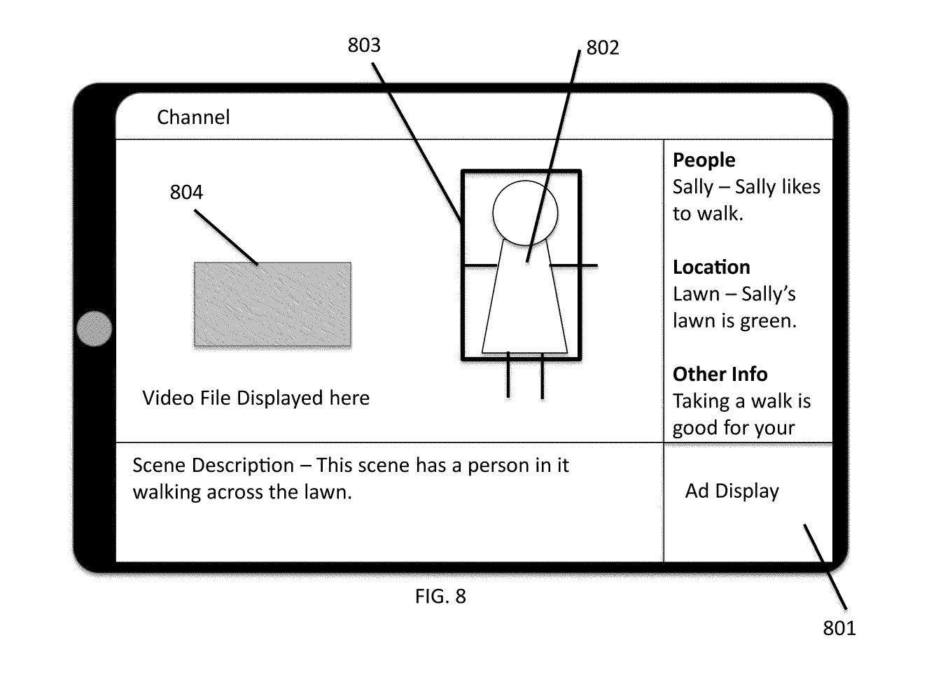

FIG. 8 is a screen shot of time and video dependent customized advertising, delivered based upon an object map and data file(s) within a video file. All of the collected data is associated with an advertising platform to generate customized advertising. A combination of the associated data file and the associated ancillary data file are used to deliver highly customized advertising in a side panel 801 within the same interface as the video file, or can appear over the object when a viewer selects the object. A user can select an object 802 which is linked to an object map 803. All collected data is associated with an advertising platform to generate customized advertising. A floating advertisement 804 can also appear elsewhere in the video.

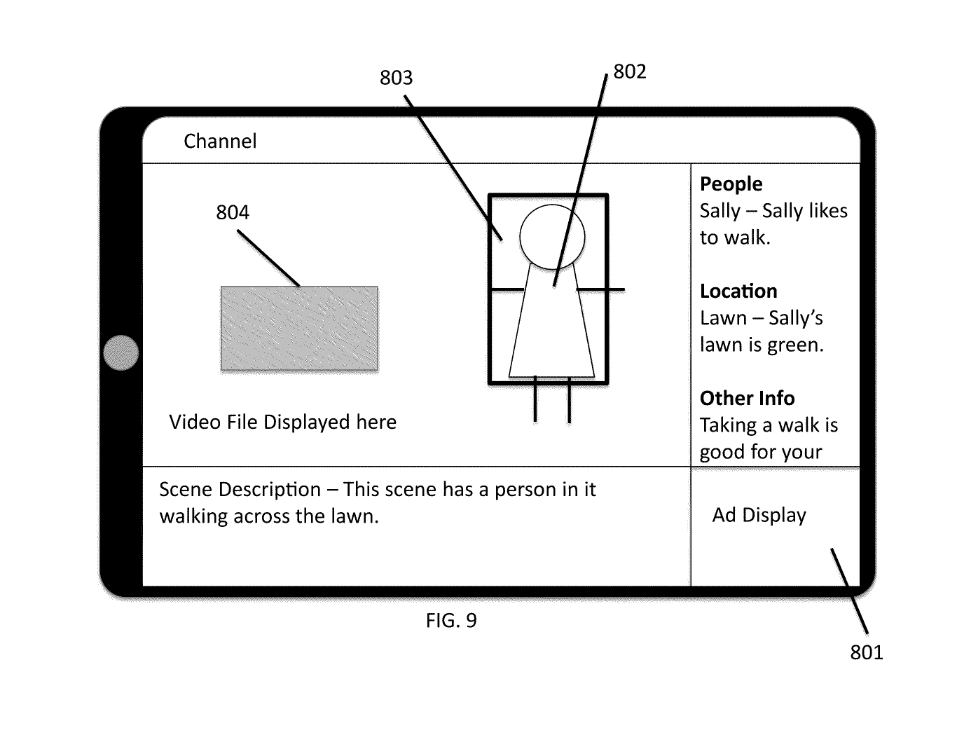

FIG. 9 is a screen shot of tracked viewer exposure to time and video dependent customized advertising, delivered based upon an object map and data file(s) within a video file. Exposure to a viewer is tracked, so that advertisers can determine how many times a viewer has been exposed to a particular advertisement. An example of what can be tracked about the viewer exposure in a data file is shown, which is an expanded version of the “Viewer Behavior” data. Also shown are the object 802, object map 803, customized advertising in a side panel 801, and floating advertisement 804.

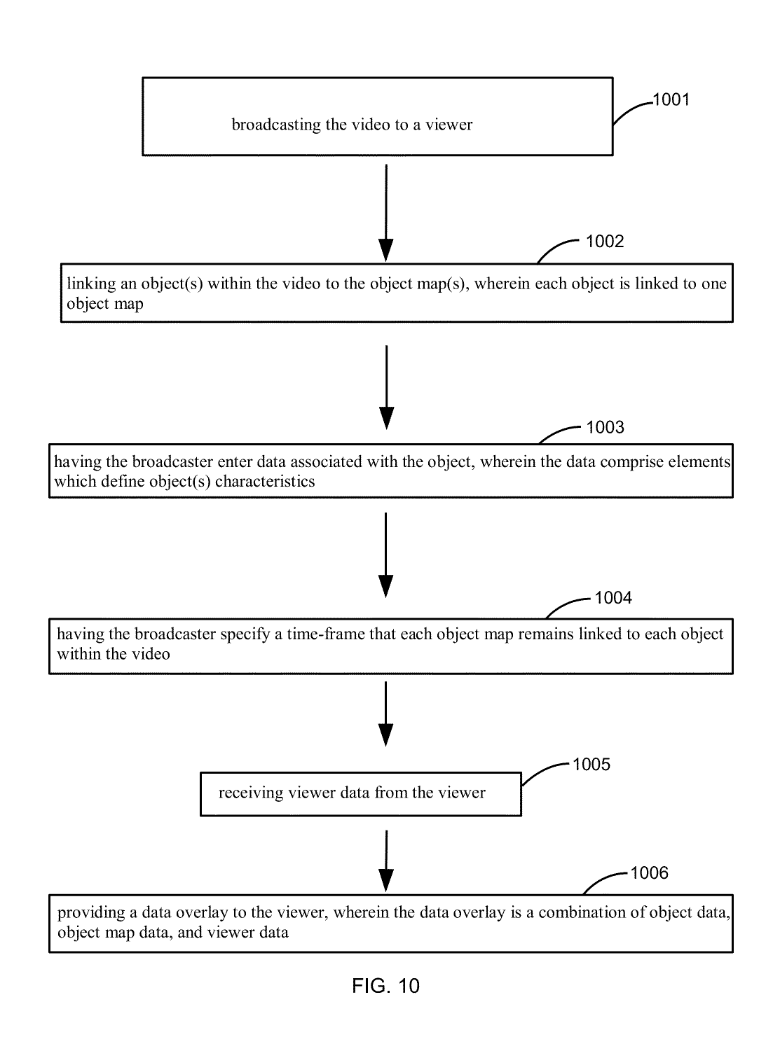

FIG. 10 is a flowchart showing an embodiment of the method. Step 1001 is broadcasting the video to a viewer; Step 1002 is linking an object(s) within the video to an object map(s), wherein each object is linked to one object map; Step 1003 is having the broadcaster enter data associated with the object map(s); Step 1004 is having the broadcaster specify the time-frame that each object map remains linked to each object within the video; Step 1005 is receiving viewer data from the viewer; and Step 1006 is providing advertising which is dependent upon a combination of object data, object map data, and viewer data.

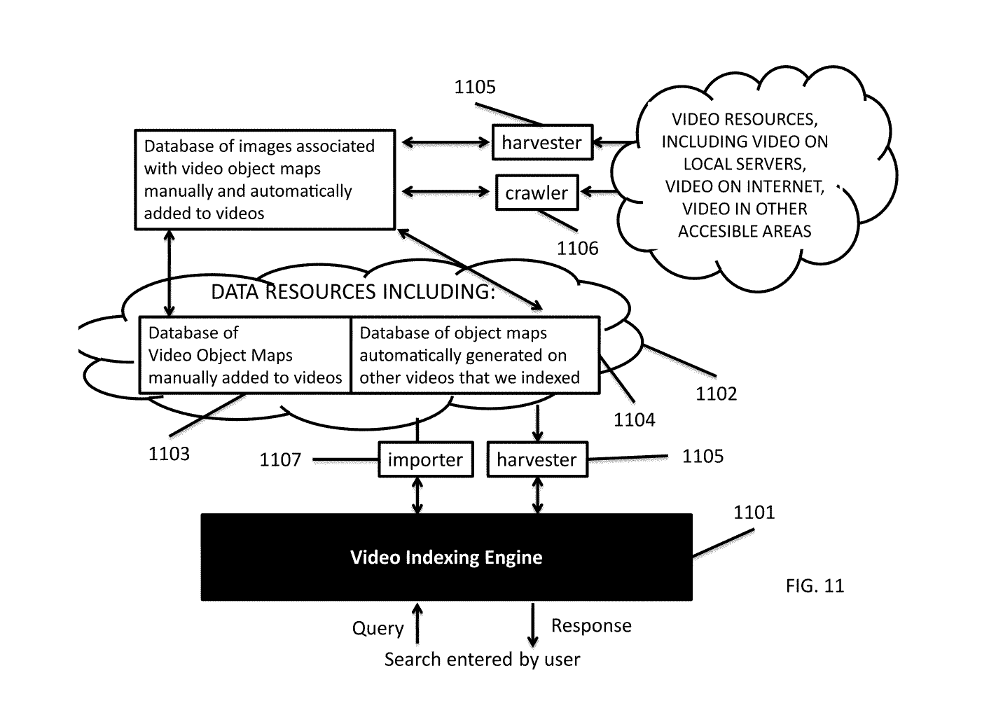

FIG. 11 is a network diagram using a local search engine. The video indexing engine 1101 is queried and returns a response consisting of a set of data points tied to specific time frames within a video based on object maps within that video. Data resources 1102 used to provide the response to the query are provided from video objects manually and automatically added to video through import and harvesting techniques. The data resources 1102 combine a database of video object maps manually added to videos 1103 and a database of object maps automatically generated from other indexed videos 1104. A database based on data and captured images associated with that data collected from both manual and automated collection of object maps is generated. Additional data and images is added to the databases in based on the harvesting and crawling of additional video resources, including videos on local servers, video in the Internet, and video in other accessible areas. A harvester 1105 transforms unstructured data collected from the automated object mapping into structured data that can be stored and analyzed by the database. The harvester 1105 takes into account all meta data associated with the video, utilizes pixel analysis, identifies scene changes within video, and segments out time segments accordingly, associating objects with each time segment, all data that is stored in the database for further analysis. A crawler 1106 and importer 1107 can work similarly to the harvester 1105. In one embodiment, data that is added to object maps and stored in the data resources 1102 can be corrected by the user entering the query, if or when that user finds the data incorrect. In this case, the data resources 1102 will be updated based on the corrections.

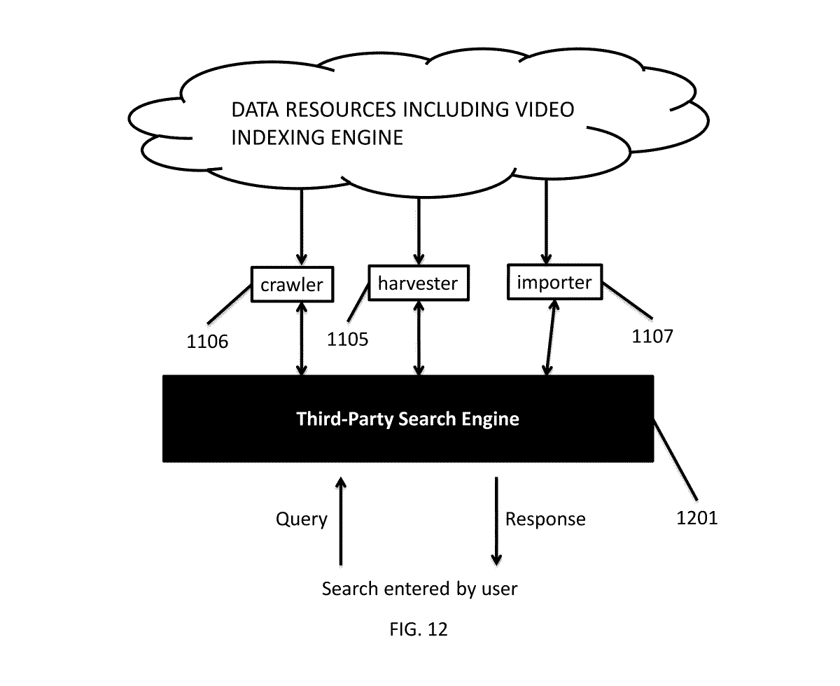

FIG. 12 is a network diagram using a third-party search engine. The search engine is queried and returns a response with results most relevant to that query. The search engine collects data to respond to the query from a variety of data sources, including the video indexing engine noted in FIG. 11. This data is primarily collected using three methods, passively crawling data from the data resources (with a crawler 1106), harvesting data through a higher level of contextual analysis of the data being provided (with a harvester 1105), and direct import of the data (with an importer 1107).

For the purposes of this disclosure, crawling is defined as the use of a computer program to capture data that is displayed on the web or in an accessible database through the process of systematically opening and detecting any content that it can access through the networks it operates on. Crawling is typically done in two steps, (1) opening and copying a video, and then (2) indexing everything about that video that can be indexed into a database for later data retrieval.

For the purposes of this disclosure, a local search engine is defined as a search engine that operates within the application or on the website that the video in use resides. Conversely, a third party search engine is defined as a search engine that is operated by a separate company on a separate website or application (such as Google or Microsoft) from where the video resides.

All patents and publications mentioned in the prior art are indicative of the levels of those skilled in the art to which the invention pertains. All patents and publications are herein incorporated by reference to the same extent as if each individual publication was specifically and individually indicated to be incorporated by reference, to the extent that they do not conflict with this disclosure.

While the present invention has been described with reference to exemplary embodiments, it will be readily apparent to those skilled in the art that the invention is not limited to the disclosed or illustrated embodiments but, on the contrary, is intended to cover numerous other modifications, substitutions, variations, and broad equivalent arrangements.

I claim:

1. A method for a broadcaster to add an object map(s) with linked data to a video residing on a server, the method comprising:
broadcasting the video to a viewer;
linking an object(s) within the video to the object map(s), wherein each object is linked to one object map;
having the broadcaster enter data associated with the object, wherein the data comprise elements which define object(s) characteristics;
having the broadcaster specify a time-frame that each object map remains linked to each object within the video;
receiving viewer data from the viewer; and
providing a data overlay to the viewer, wherein the data overlay is a combination of object data, object map data, and viewer data.

2. The method of claim 1, further comprising after the last step, presenting the data associated with the object(s) to the viewer and enabling the viewer to access the linked time-frames via the data overlay.

3. The method of claim 1, further comprising after the last step, presenting the data associated with the object(s) to the viewer and enabling the viewer to access a time frame which is related to the data associated with the object(s).

4. The method of claim 1, further comprising after the last step, grouping the data associated with the object map(s), wherein the grouping enables the viewer to access the time-frame that each object map remains linked to each object within the video.

5. The method of claim 1, wherein the object map is indexed in a local database.

6. The method of claim 5, wherein the time-frame is a function of a scene change within the video.

7. The method of claim 6, wherein the object(s) are further defined as comprising elements, (i.e. characteristics of the object such as style, color, size, and other aspects).

8. The method of claim 7, wherein algorithms are used to identify elements which are used in more than one object.

9. The method of claim 8, wherein the data associated with the object map(s) is also associated with the elements.

10. The method of claim 1, wherein the object map is indexed in a local database which is combined with a third-party database.

11. The method of claim 10, wherein the time-frame is a function of a scene change within the video.

12. The method of claim 11, wherein the object(s) are further defined as comprising elements.

13. The method of claim 12, wherein algorithms are used to identify elements which are used in more than one object.

14. The method of claim 13, wherein the data associated with the object map(s) is also associated with the elements.
